(19) United States
(12) Patent Application Publication
(10) Pub. No.: US 2002/0073808 A1
(43) Pub. Date: Jun. 20, 2002

(54) Housing for a power tool

(76) Inventors: James A. Jamra, Madison, CT (US); Peter A. Rosa, Madison, CT (US); Marvin W. Burkhalter III, Mystic, CT (US)

Correspondence Address: Bachman & LaPointe, P.C., Suite 1201, 900 Chapel Street, New Haven, CT, 06510-2802, US

(21) Appl. No.: 09/738,707

(22) Filed: Dec. 15, 2000

(51) Int. Cl. B25B 13/46; B25B 17/00

(52) U.S. Cl. 81/57.39

(57) ABSTRACT

The present invention relates to an improved housing for use in power tools such as power wrenches. The improved housing is formed by a unibody construction having a cylindrical portion for housing a drive unit for the tool and an integrally formed shroud for housing a rotatable wheel and a linkage system for rotating the wheel, which shroud has a front opening. The shroud is immovable relative to the cylindrical portion and includes an upper wall, two side walls and a lower wall. The lower wall has a substantially linear portion and an arcuately shaped central web structure extending from the linear portion. The front opening in the shroud is formed by a front edge of the upper wall, an upper edge of the central web structure, and edges of the two side walls. The housing further has a cover for closing the front opening in the shroud, which cover is attached to and overlaps both a front portion of the upper wall and the lower wall.

### BACKGROUND OF THE INVENTION

The present invention relates to a power tool, such as a power wrench, having an improved housing.

Hydraulically powered wrenches have been used for many years now to tighten and loosen threaded connections in a wide variety of situations. U.S. Pat. No. 4,201,099 to Junkers; U.S. Pat. No. 4,233,865 to Junkers; U.S. Pat. No. 4,336,727 to Junkers; U.S. Pat. No. 5,003,847 to Wagner; and U.S. Pat. No. 5,823,075 to Torrekens illustrate some of these hydraulically powered wrenches.

Many of the housings in hydraulic wrenches currently in use suffer from a number of problems. For example, they do not provide tool stability and cannot resist flexure and torsion during operation. In some of these hydraulic wrenches, portions of the housing are movable relative to each other to prevent collisions between a piston rod connected to the piston-cylinder drive unit and portions of the housing. The Hytorc tool, for example, uses a spring loaded shroud which loosely fits together for anticipated piston rod collisions. Because of the loose fit and a large, shroud spring mounting hole, dirt and contaminants easily enter the tool interior causing excessive wear and damage to the interior parts.

Thus, there remains the need for improved housings for power tools.

### SUMMARY OF THE INVENTION

Accordingly, it is an object of the present invention to provide an improved housing for a power tool.

It is a further object of the present invention to provide a housing for a power tool that has increased tool stability and resistance to flexure and torsion during operation.

It is yet a further object of the present invention to provide a housing for a power tool that substantially reduces the amount of dirt and contaminants that can enter the interior of the tool.

The foregoing objects are attained by the housing and the improved power tool of the present invention.

In accordance with the present invention, an improved power tool is provided. The power tool has a housing which comprises a unibody housing having a cylindrical portion for housing a drive unit for the tool and an integrally formed shroud having an opening for housing a rotatable wheel and a linkage system for rotating the wheel. The shroud is immovable relative to the cylindrical portion and includes an upper wall, two side walls, and a lower wall. The lower wall has a substantially linear portion and an arcuately shaped central web extending from the substantially linear portion. The central web increases tool stability and resistance to flexure and torsion during operation. There is a front opening formed in the shroud by a front edge of the upper wall, an upper edge of the central web, and edges of the two side walls. The housing further has a cover structure that overlaps and is attached to a front portion of the upper wall and to the lower wall.

Other details of the housing and the power tool, as well as other objects and advantages attendant thereto, are set forth in the following detailed description and the accompanying drawings, wherein like reference numerals depict like elements.

### BRIEF DESCRIPTION OF THE DRAWINGS

FIG. 1 is a perspective view of the improved housing of the present invention;

FIG. 2 is a side view of the housing of the present invention;

FIG. 3 is a front view of the housing of the present invention;

FIG. 4 is a rear view of the housing of the present invention;

FIG. 5 is a sectional view of a power tool using the housing of the present invention;

FIG. 6 is a perspective view of a drive pawl assembly used in the power tool of the present invention;

FIG. 7 is a perspective view of a reaction pawl assembly used in the power tool of the present invention; and

FIG. 8 is a perspective view of a power tool in accordance with the present invention having a reaction arm attached thereto.

### DETAILED DESCRIPTION OF THE PREFERRED EMBODIMENT(S)

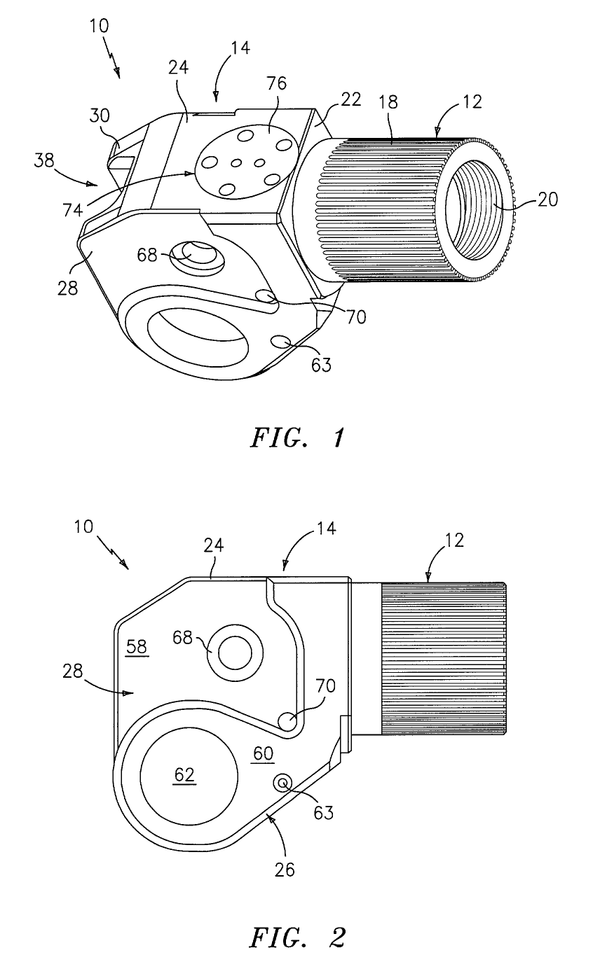

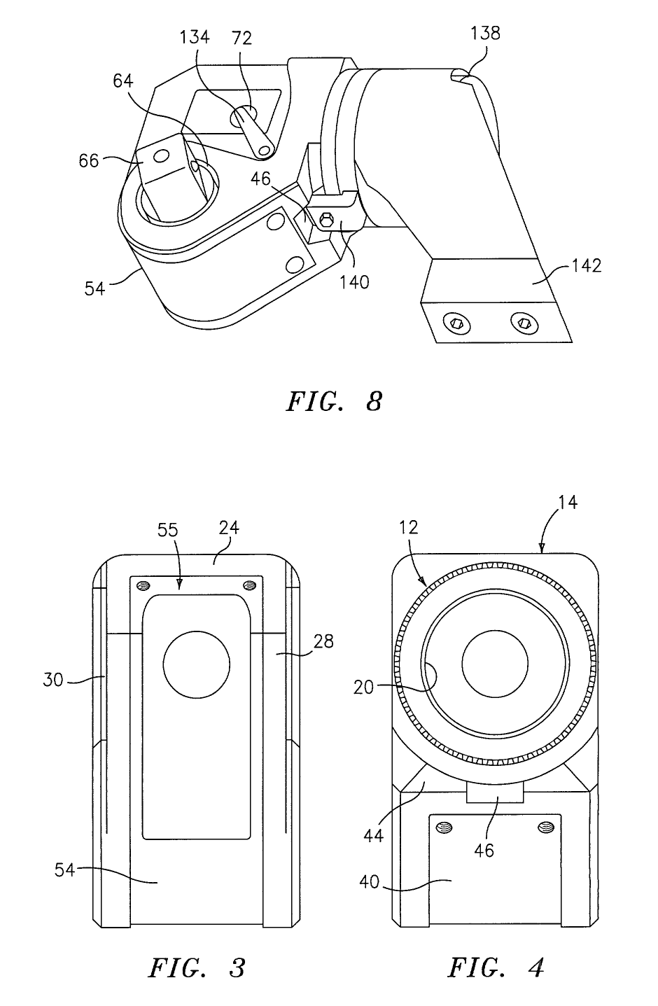

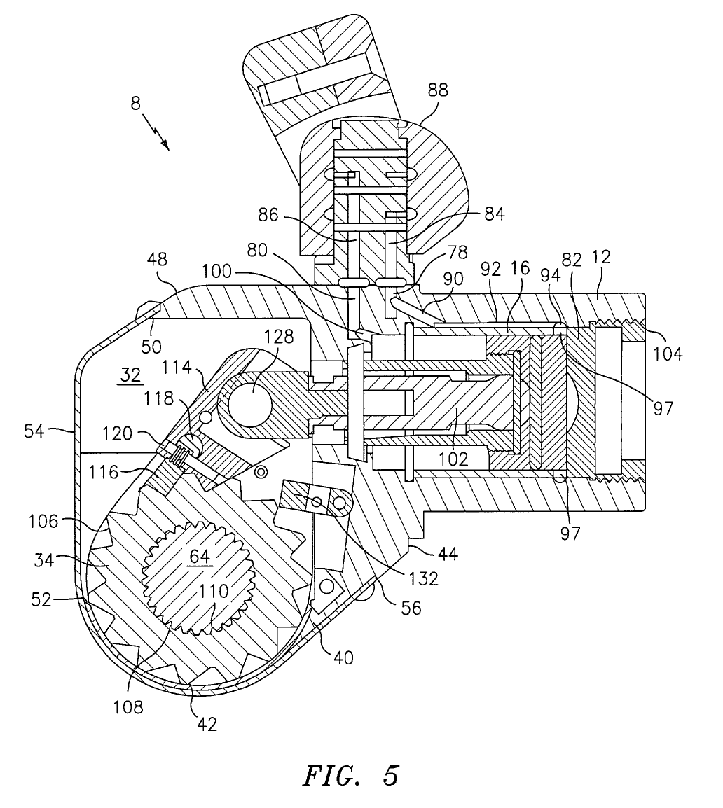

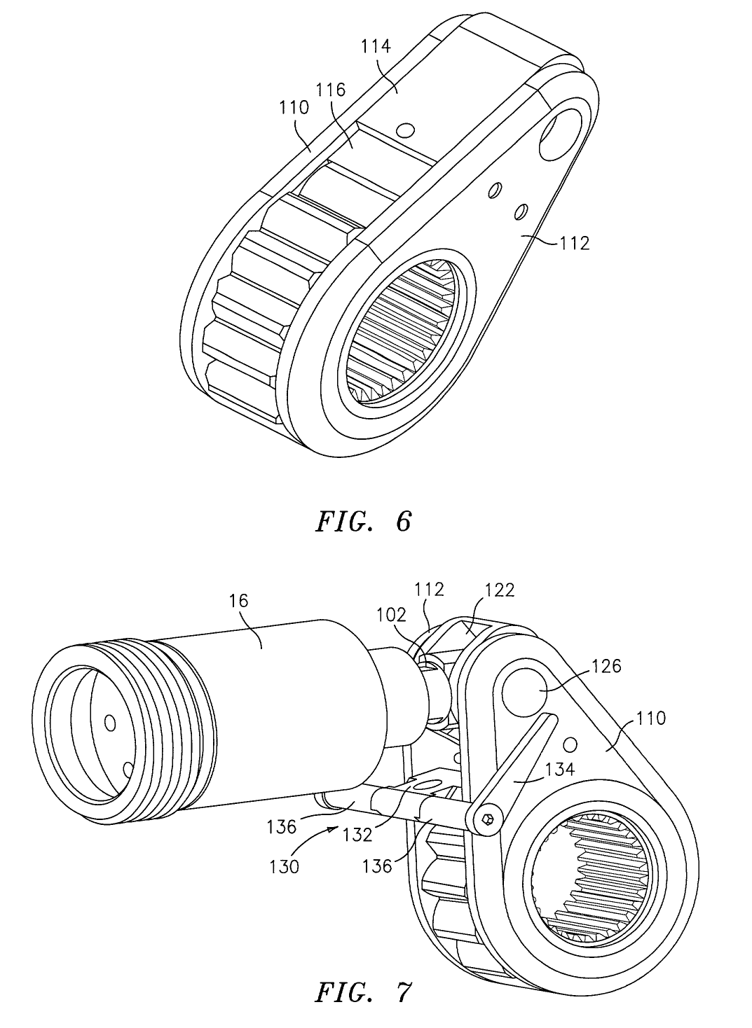

Referring now to the drawings, FIGS. 1-4 illustrate the improved housing of the present invention and FIGS. 5-8 illustrate a power tool employing the housing. As shown in FIGS. 1-4, the housing 10 has a unibody or one-piece construction. The housing 10 may be formed from any suitable metal or non-metallic material using any suitable casting or forming technique known in the art. For example, the housing 10 may be a cast structure.

The housing 10 includes a cylindrical portion 12 and a front shroud 14 which is fixed to the front of the cylindrical portion 12. As will be discussed hereinafter, the cylindrical portion 12 houses the drive unit 16 for the power tool. The cylindrical portion 12 has a ribbed outer surface 18 and a threaded end portion 20.

The front shroud 14 is defined by a rear wall 22 which mates with the front edge of the cylindrical portion, an upper wall 24, a lower wall 26 and two side walls 28 and 30 which extend from the upper wall 24 to the lower wall 26. The walls of the shroud 14 define a compartment 32 for housing a rotatable wheel 34 and a linkage system 36 for rotating the wheel 34. In order to provide access to these components, the shroud has a front opening 38.

In order to increase the strength of the housing 10, the upper wall 24 may have an increased thickness over housings in other power tools. If desired, the upper wall 24 may be provided with an access port 74 and/or a cover 76 for closing the access port 74.

As shown in FIG. 5, the lower wall 26 has a substantially linear portion 40 and an arcuately shaped central web 42 extending from the linear portion 40. The central web 42 is integral to the housing and adds both strength and rigidity. The linear portion 40 of the lower wall is connected to the cylindrical portion 12 and the rear wall 22 by a substantially planar wall 44. As shown in FIG. 4, the wall 44 may have a notch 46 whose purpose will be discussed hereinafter. The upper wall 24 is preferably provided with an angled front surface 48. The front opening 38 is defined by the lower edge 50 of the front surface 48, the upper edge 52 of the central web 42, and the two side walls 28 and 30.

The central web 42 is provided to increase the structural integrity of the housing 10. The central web 42 is solid and therefore increases the resistance to torsion and flexure during operation. It also increases tool stability.

As shown in FIG. 5, the cover 54 is provided to close the opening 38 and to increase structural integrity to the housing 10. The cover 54 when positioned over the front opening 38 also overlaps an angled front section 48 of the upper wall 24 and the central web 42 of the lower wall. It also partially overlaps the substantially linear portion 40. One end of the cover 54 abuts a shoulder 56 formed in the lower wall 26 while the other end of the cover 54 rests in a notched section 55 formed by portions of the side walls 28 and 30 and the upper wall 24. The cover 54 may be secured to the lower wall 26 and to the upper wall 24 using any suitable fastener known in the art.

The two side walls 28 and 30 are designed to provide strength where needed. To this end, each side wall has a substantially planar portion 58 and a raised or thickened portion 60. The thickened portion 60 of each side wall has an opening 62 therein, which opening 62 is aligned with the central web 42. The opening 62 in one of the side walls will receive a cylindrical member 64 which mates with the wheel 34. The cylindrical member 64 preferably has a male member 66 for engaging a socket (not shown) which in turn engages a threaded connector (not shown) to be tightened or loosened. The opening 62 in the other of the side walls receives a removable cover plate (not shown) for gaining access to the interior of the wheel 34 and the interior of the tool 8. The removable cover plate may be provided with a lock/release mechanism (not shown) to hold the cylindrical member 64 in position. The thickened portion 60 also has an opening 63 through which a reaction pawl pin slips inside and attaches to the reaction pawl spring. A set screw is then threaded into the opening 63 to hold the pin in place.

The substantially planar portion 58 of each side wall is provided with openings 68 and 70. The opening 68 is an access port which allows access to the linkage system 36. The opening 68 is preferably threaded to receive a cap seal 72. The cap seals may be provided with facial seals to prevent dirt from the external environment from entering the interior of the tool. The opening 70 allows a portion of a reaction pawl release system to extend through each side wall.

The housing 10 of the present invention has been designed to maximize material where it is required, i.e. along the load path between drive unit and the square drive axis, when torque is being generated. Further, the housing has been designed to minimize material outside the torsional load path between the piston axis and the square drive axis. Consequently, the tool strength is maximized while the weight is minimized.

Referring now to FIG. 5, the power tool 8 has a drive unit 16 formed by a piston-cylinder unit. As shown in this figure, the piston-cylinder unit is seated within the cylindrical portion 12. An operating fluid delivery port 78 and a return port 80 are machined into the housing for delivering an operating fluid, such as hydraulic fluid, to the piston-cylinder unit to move the piston 82 from a fully retracted position to a fully extended position and viceversa. The ports 78 and 80 mate with fluid passageways 84 and 86 in a fluid connection device 88 mounted to the upper wall 24. The port 78 communicates with a chamber on one side of the piston 82 via a passageway 90 machined in the housing, a housing cavity 92, and an annular groove 94 in the housing. The cylinder 96 has two sleeve holes 97 which communicate with the annular groove 94 so that the operating fluid enters the holes and the cavity in front of the piston 82. The return port 80 communicates with the chamber 98 via passageway 100.

A plug 104 is threaded into the cylindrical portion 12 to secure the piston-cylinder unit 16 within the cylindrical portion 12. The plug 104 may have hollowed out sections to eliminate unnecessary weight.

The piston 82 has a piston arm 102 attached to one side. The piston arm 102 may be attached to the piston 82 in any suitable manner known in the art.

As shown in FIG. 5, the rotatable wheel 34 comprises a ratchet wheel having a plurality of external teeth 106 and a plurality of interior splines 108. The splines 108 engage with a plurality of splines 110 on the cylindrical member 64 so that the cylindrical member 64 rotates with the ratchet wheel 34.

The linkage system 36 extends between one end of the piston arm 102 and the ratchet wheel 34. As shown in FIGS. 5, 6 and 7, the linkage system comprises two spaced apart universal plates or arms 110 and 112, a drive pawl arm 114, and a drive pawl 116 positioned within a groove 118 in the drive pawl arm 114. The lower portions of the arms 110 and 112 are positioned adjacent the sidewalls of the ratchet wheel 34 and are curved to allow rotation of the drive arms 110 and 112 about an axis coincident with the axis of rotation of the ratchet wheel 34. The drive pawl 116 is preferably fixed to the drive pawl arm 114 by a pin 120.

The drive pawl arm 114 has a slot 122 into which an end of the piston arm 102 is received. A pin 124 passes through openings 126 in arms 110 and 112, through aligned openings (not shown) in the drive pawl arm 114, and through an opening 128 in the piston arm.

As the piston 82 is moved from its fully retracted position to its fully extended position, the piston arm 102 is advanced. This causes the arms 110, 112, and 114 to rotate about the central axis of the ratchet wheel 34. Movement of the arms 110, 112, and 114 causes the drive pawl 116 to push against one of the teeth 106, or another type of engaging feature, and thereby cause rotation of the wheel 34.

To prevent rotation of the ratchet wheel 34 as the piston 82 moves from the fully extended position to the fully retracted position, the reaction pawl assembly 130 shown in FIG. 7 is provided. The reaction pawl assembly 130 includes a reaction pawl 132 which engages the exterior teeth 106 of the ratchet wheel and a reaction pawl spring (not shown). As shown in FIG. 7, the reaction pawl assembly 130 includes release levers 134 attached to the reaction pawl 132 by pin members 136. The pin members 136 pass through the apertures 70 in the side walls 28 and 30 to allow the release levers 134 to be positioned externally of the housing 10. The release levers 134 may be used to rotate the reaction pawl 132 out of engagement with the teeth 106, or other type of engaging service, so that the ratchet wheel 34 may be turned when the piston moves from the fully extended position to the fully retracted position.

Referring now to FIG. 8, the power tool 8 may be provided with a reaction arm 138. As shown therein, the reaction arm 138 fits over the cylindrical portion 12. The reaction arm 138 may be secured to the housing 10 by a locking device 140 which is seated in notch 46 or by an engagement device mounted in the rear portion of the reaction arm cylindrical bore. If the latter engagement device is used, notch 46 can be eliminated. The locking device 140 may comprise any suitable locking device known in the art for securing the reaction arm 138 to the casing 10. If desired, an abutment member 142 may be placed over and secured to an end of the reaction arm. The abutment member 142 may be formed from any suitable material known in the art and may be secured to the reaction arm 138 in any desired manner.

While the power tool 8 has been described as having a cylindrical member 64 with a male member 66 attached to the ratchet wheel 34, a socket (not shown) could directly engage the ratchet wheel 34 if desired.

If desired, a flow regulation system could be incorporated into the tool 8. Such a flow regulation system is described in co-pending U.S. patent application Ser. No. 09/643,284, filed on Aug. 22, 2000, entitled FLOW REGULATION DEVICE, which is incorporated by reference herein.

As can be seen from the foregoing discussion that an improved power tool, in particular an improved power wrench, has been provided in accordance with the present invention. The power tool has a housing which has been designed to have increased strength, better tolerance control for 100% part interchangeability, enhanced features to withstand flexure and torsional loads, while optimizing in weight and small profile for tight space applications. The housing is further constructed with environmental seals, sealing caps, and cover to prevent foreign matter to enter the tool. These environmental sealing enhancements decrease internal part wear and increase overall tool longevity. The housing also allows access to the interior of the tool when needed to service the tool.

It is apparent that there has been provided in accordance with the present invention an improved housing for a power tool which fully satisfies the objects, means, and advantages set forth hereinbefore. While the present invention has been described in the context of specific embodiments thereof, other variations, alternatives, and modifications will become apparent to those skilled in the art having read the foregoing description. Therefore, it is intended to embrace those variations, alternatives, and modifications which fall within the broad scope of the appended claims.

What is claimed is:

1. A housing for a power tool comprising:
a unibody construction having a cylindrical portion for housing a drive unit for said tool and an integrally formed shroud for housing a rotatable wheel and a linkage system for rotating said wheel, which shroud has a front opening;
said shroud being immovable relative to said cylindrical portion and including an upper wall, two side walls, and a lower wall;
said lower wall having a substantially linear portion and an arcuately shaped central web extending from said substantially linear portion; and
said opening being formed by a front edge of said upper wall, an upper edge of said central web, and edges of said two side walls,
whereby said arcuately shaped central web increases tool stability, resistance to flexure, and resistance to torsional loads.

2. A housing according to claim 1, further comprising a cover for closing said opening and said cover being attached to and overlapping a front portion of said upper wall and a portion of said lower wall.

3. A housing according to claim 1, wherein said front portion of said upper wall has an angled surface and said cover is attached to said angled surface.

4. A housing according to claim 1, wherein said lower wall has a shoulder in said substantially linear portion and said cover abuts said shoulder and is joined to said substantially linear portion of said wall.

5. A housing according to claim 1, wherein said cylindrical portion has a threaded end portion and a ribbed exterior surface.

6. A housing according to claim 1, wherein said shroud has a rear wall and said housing further has a substantially planar wall structure extending between said rear wall and said substantially linear portion of said lower wall.

7. A housing according to claim 6, wherein said substantially planar wall has a notch therein.

8. A housing according to claim 1, wherein each of said side walls has a first substantially planar portion and a raised portion and a first opening in said raised portion which is aligned with said central web.

9. A housing according to claim 8, wherein each of said side walls has an access hole in said first substantially planar portion for gaining access to said linkage system and said access hole being threaded to receive a cap seal.

10. A housing according to claim 9, wherein each of said side walls further has a second opening in said substantially planar portion for allowing part of a pawl release system to pass therethrough.

11. A housing according to claim 1, wherein said upper wall has an access port.

12. A power tool comprising:
a unibody housing having a cylindrical portion for housing a drive unit for said tool and an integrally formed shroud for housing a rotatable wheel and a linkage system for rotating said wheel, said shroud having a front opening;
said shroud being immovable relative to said cylindrical portion and including an upper wall, two side walls, and a lower wall;
said lower wall having a substantially linear portion and an arcuately shaped central web structure extending from said substantially linear portion; and
said opening being formed by a front edge of said upper wall, an upper edge of said central web structure, and edges of said two side walls.

13. A power tool according to claim 12, further comprising a cover for closing said opening and said cover being removably attached to and overlapping a front portion of said upper wall and a portion of said lower wall.

14. A power tool according to claim 12, wherein said drive unit comprises a fluid actuated piston-cylinder unit positioned within said cylindrical portion.

15. A power tool according to claim 14, said unibody housing having fluid passageways machined therein for delivering an operating fluid to said piston-cylinder unit to move said piston between a retracted position and a fully extended position for driving said wheel.

16. A power tool according to claim 15, further comprising:
said piston having a piston rod attached to one surface and said piston rod extending into a compartment formed by said shroud;
said wheel comprising a ratchet wheel;
said linkage comprising two spaced apart arms and a drive pawl assembly positioned between said arms for engaging said ratchet wheel; and
said arms and said drive pawl assembly being attached to said piston rod for causing said ratchet wheel to rotate as said piston is moved from said fully retracted position to said fully extended position.

17. A power tool according to claim 16, further comprising a reaction pawl for preventing rotation of said ratchet wheel as said piston moves from said fully extended position to said retracted position.

18. A power tool according to claim 17, further comprising a release lever for releasing said reaction pawl from contact with said ratchet wheel.

19. A power tool according to claim 16, further comprising a cylindrical member attached to said ratchet wheel and extending through one of said side walls and said cylindrical member having a male member for engaging a socket.

20. A power tool according to claim 12, further comprising a reaction arm attached to said housing and overlapping at least a portion of said cylindrical housing.

21. A power tool according to claim 20, further comprising an abutment member attached to an end of said reaction arm.

22. A power tool according to claim 20, wherein said shroud has a rear wall and a substantially planar wall connecting said rear wall to said substantially linear portion of said lower wall and said substantially planar wall has a notch for receiving a locking device for securing said reaction arm to said housing.
